(19) United States
(12) Patent Application Publication
(10) Pub. No.: US 2008/0055438 A1
(43) Pub. Date: Mar. 6, 2008

(54) IMAGE SENSOR PACKAGE, RELATED METHOD OF MANUFACTURE AND IMAGE SENSOR MODULE

(75) Inventors: Chung-sun Lee, Gunpo-si (KR); Yong-hwan Kwon, Suwon-si (KR); Un-byoung Kang, Hwaseong-si (KR); Woon-seong Kwon, Suwon-si (KR); Hyung-sun Jang, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 11/842,993

(22) Filed: Aug. 22, 2007

(30) Foreign Application Priority Data
Aug. 30, 2006 (KR) 10-2006-0082921

(51) Int. Cl. H04N 5/335

(52) U.S. Cl. 348/294

(57) ABSTRACT

The image sensor package includes: an image sensor chip including an image sensing unit which is positioned in an upper central portion thereof and including a plurality of chip bonding pads formed around the image sensing; a transparent board including a lower surface on which a first line electrically connected to the chip bonding pads is formed and the transparent board being arranged with the image sensor chip so that the lower surface faces the image sensing unit; and a plurality of second lines connected to the first line and extending along sidewalls of the image sensor chip to be exposed under a lower surface of the image sensor chip.

### CROSS-REFERENCE TO RELATED PATENT APPLICATION

This application claims the benefit of Korean Patent Application No. 10-2006-0082921, filed on Aug. 30, 2006, the subject matter of which is hereby incorporated by reference.

### BACKGROUND OF THE INVENTION

1. Field of the Invention

The present invention relates to an image sensor package, a method of manufacture, and an image sensor module incorporating same. More particularly, the invention relates to a slim image sensor package capable of preventing contamination by micro-particles, as well as a related method of manufacture, and an image sensor module incorporating same.

2. Description of Related Art

Charge-coupled device (CCD) sensors dominate many applications within the image sensor market. However, the complementary metal-oxide semiconductor (CMOS) image sensors are gaining wider market acceptance and are one day expected to exceed the CCD use. For example, CMOS image sensors have enjoyed a sudden rise in demand due to their use within mobile devices that require low power consumption. The rising demand for CMOS image sensors has also been driven by applications that require high performance, dense integration, high speed operation, and good overall pixel characteristics, etc.

However, CMOS image sensors are highly susceptible to environmental contamination (e.g., particle contamination) in ways that typical CMOS devices are not. Where the size of the CMOS image sensors is not particularly important, leadless chip carrier (LCC) type packages may be used to help mitigate the contamination problems. However, other applications demanding light, thin, short, and/or small CMOS image sensors, such as camera phones, require CMOS sensor packaging like chip-on-boards (COBs), chip-on-films (COFs), chip size packages, etc.

FIG. (FIG.) 1 is a cross-sectional view of a conventional CMOS image sensor module packaged using a COB method. Referring to FIG. 1, the image sensor module includes an image sensor chip 10, a printed circuit board (PCB) 20, a lens unit, and a flexible printed circuit (FPC) 40. The image sensor chip 10 is mounted on the PCB 20. The lens unit includes a lens 32, a lens holder 34, and an infrared (IR) blocking filter 36. The lens 32 and the lens holder 34 are mounted in the PCB 20 above the image sensor chip 10. Also, the lens 32 focuses light onto an active pixel sensor (APS) 12. The IR blocking filter 36 blocks IR rays from being transmitted to the image sensor chip 10. The FPC 40 is connected to the PCB 20.

In the image sensor module shown in FIG. 1, a lower surface of the image sensor chip 10 is bonded to the PCB 20 using a die adhesive 22, and then a chip bonding pad 14 of the image sensor chip 10 is connected to a bonding pad 24 of the PCB 20 using bonding wires 16. This COB method uses a process similar to existing semiconductor techniques that offer high productivity. However, the COB method requires a space for wire bonding. Thus, the size of the image sensor module is increased, and the height of the image sensor module is increased in consideration of the height of wires 24 and IR blocking filter 36.

FIG. 2 is a cross-sectional view of an image sensor module packaged using a conventional COF method. Referring to FIG. 2, in the image sensor module shown in FIG. 2, an image sensor chip 10 is bonded to a board 42 such as a flexible PCB or a flexible FPC using an anisotropic conductive film (ACF) 23 adopting the COF method. Here, bonding wires are not used, and an IR blocking filter 37 may be formed on the board 42. Thus, the width and height of the lens unit may be reduced. As a result, the image sensor module may be made light, thin, short, and small. However, a hole having the width of image sensing unit 12 must be cut in the board 42 to allow light passage to the image sensing unit 12. Here, the image sensor chip 10 may become contaminated by particles generated the process cutting away a portion of the board 42. Also, it is difficult at times to arrange the board 42 following formation of the hole in relation to the image sensor chip 10 and/or the ACF 23.

### SUMMARY OF THE INVENTION

Embodiments of the invention provide an image sensor package which may be light, thin, short, and/or small and yet which prevent contamination by particles. Embodiments of the invention also provide a related method of manufacturing the image sensor package, and an image sensor module including the image sensor package.

In one embodiment, the invention provides an image sensor package comprising; an image sensor chip comprising an image sensing unit centrally positioned on an upper portion and comprising a plurality of chip bonding pads formed around the image sensing unit, a transparent board, a plurality of first line layers formed on a lower surface of the transparent board facing the image sensing unit and electrically connecting the chip bonding pads, and a plurality of second line layers connected to the first line layers and extending along sidewalls and a bottom surface of the image sensor chip.

In another embodiment, the invention provides an image sensor module comprising; a circuit board, an image sensor package mounted on the circuit board, and a lens unit formed on the image sensor package, wherein the image sensor package comprises; an image sensor chip comprising an image sensing unit centrally positioned on an upper portion and comprising a plurality of chip bonding pads formed around the image sensing unit, a transparent board, a plurality of first line layers formed on a lower surface of the transparent board facing the image sensing unit and electrically connecting the chip bonding pads, and a plurality of second line layers connected to the first line layers and extending along sidewalls and a bottom surface of the image sensor chip.

In another embodiment, the invention provides a method of manufacturing an image sensor package, comprising; providing a plurality of image sensor chips each comprising an image sensing unit centrally positioned on an upper portion and comprising a plurality of chip bonding pads formed around the image sensing unit, providing a wafer level transparent board, a plurality of unit areas comprising a plurality of first lines corresponding to the plurality of chip bonding pads formed on a lower surface of the transparent board, bonding the image sensor chips to the unit areas of the transparent board such that the image sensor unit faces the lower surface of the transparent board, forming a photosensitive polymer layer on the entire surface of the transparent board on which the image sensor chips are bonded, forming a plurality of through holes inside the photosensitive polymer layer to expose portions of the first line layers, filling the through holes to form a plurality of second line layers exposed under the respective lower surfaces of the image sensor chips, adhering the wafer mounting tape on an upper surface of the transparent board, removing portions of the photosensitive polymer layer and the transparent board between the adjacent unit areas, filling the removed portions of the photosensitive polymer layer and the transparent board between the adjacent unit areas with an opaque resin layer, and blocking a portion of the opaque resin layer to separate a plurality of image sensor packages each corresponding to a unit area.

### BRIEF DESCRIPTION OF THE DRAWINGS

Embodiments of the invention will be described with reference to the attached drawings in which:

FIG. 1 is a cross-sectional view of a conventional image sensor module packaged using a chip-on-board (COB) method;

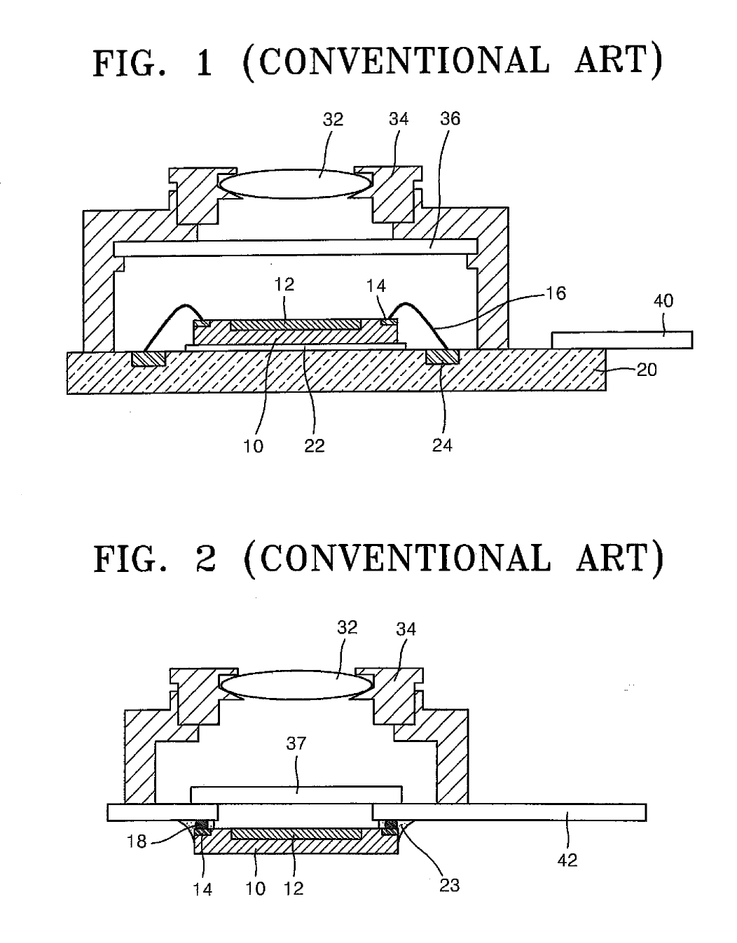

FIG. 2 is a cross-sectional view of a conventional image sensor module packaged using a chip-on-film (COF) method;

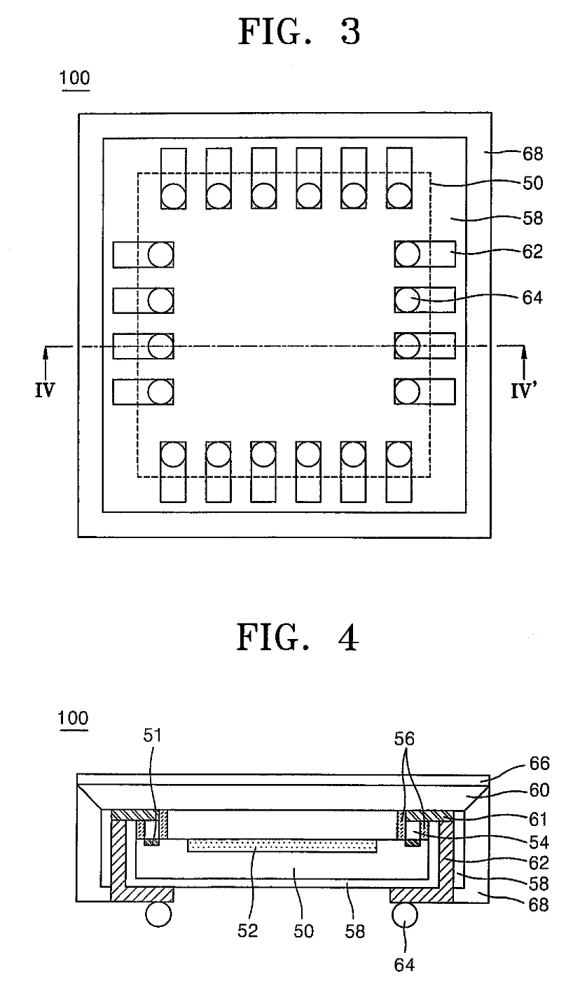

FIG. 3 is a schematic bottom view of an image sensor semiconductor package according to an embodiment of the invention;

FIG. 4 is a schematic cross-sectional view taken along line IV-IV′ of FIG. 3;

FIGS. 5 through 11 are related cross-sectional views illustrating a method of manufacturing an image sensor semiconductor package according to an embodiment of the invention;

FIG. 12 is a cross-sectional view of an image sensor module including the image sensor semiconductor package illustrated in FIG. 4, according to an embodiment of the invention; and

FIG. 13 is a cross-sectional view of an image sensor module including the image sensor semiconductor package illustrated in FIG. 4, according to another embodiment of the invention.

### DESCRIPTION OF EMBODIMENTS

Embodiments of the invention will now be described in some additional detail with reference to the accompanying drawings. The invention may, however, be embodied in many different forms and should not be construed as being limited to only the illustrated embodiments. Rather, these embodiments are presented as teaching examples. In the drawings, the relative size and shape of various layers and elements may have been exaggerated for clarity of illustration. Throughout the written description and drawings, like reference numerals are used to denote like or similar elements.

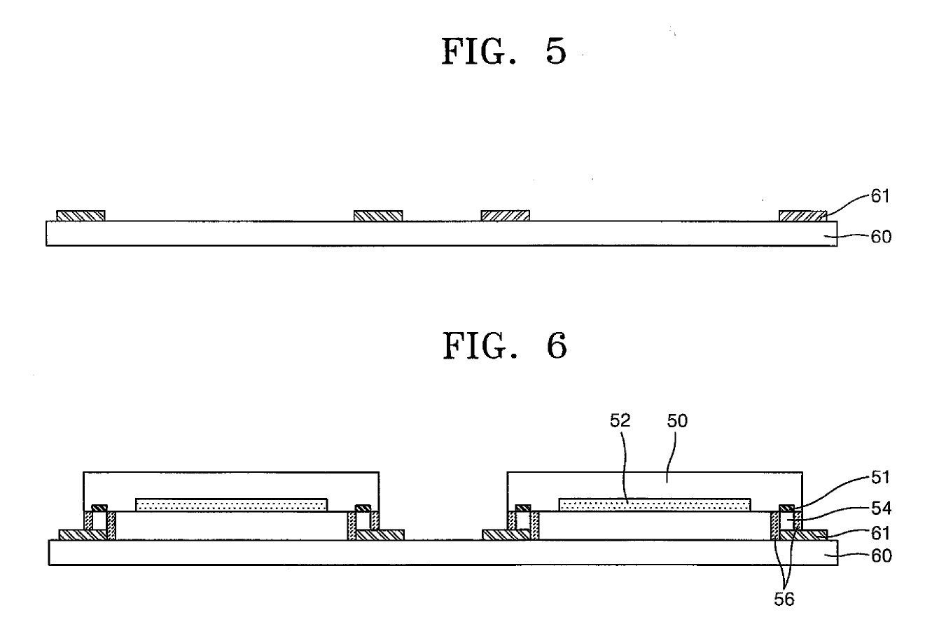

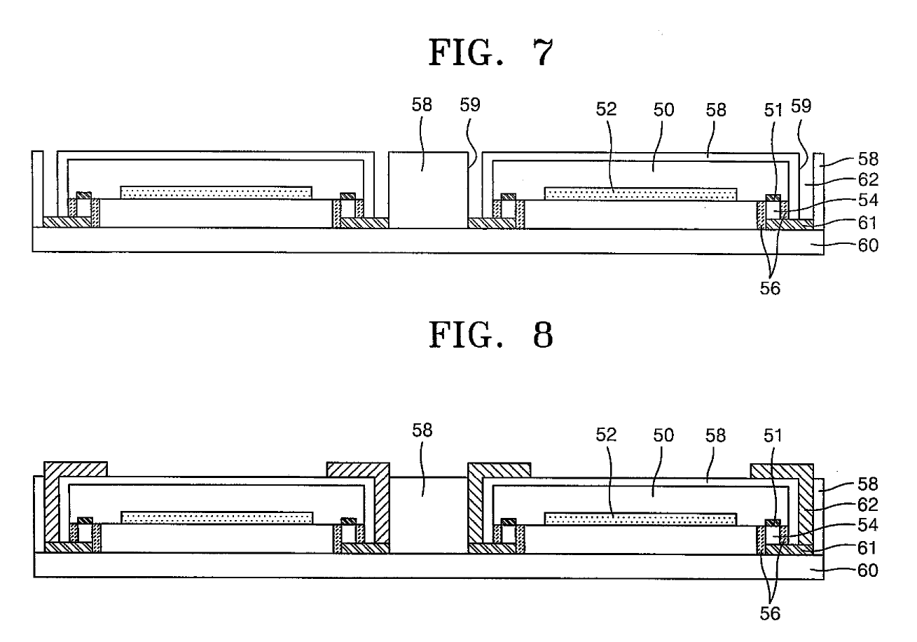

FIG. 3 is a schematic bottom view of an image sensor semiconductor package according to an embodiment of the invention. FIG. 4 is a cross-sectional view taken along line IV-IV′ of FIG. 3. Referring to FIGS. 3 and 4, in an image sensor package 100, an image sensor chip 50 is bonded to a transparent board 60 using (e.g.,) a flip chip method. An image sensing unit 52 called an active pixel sensor is formed in an upper portion of the image sensor chip 50 to face a lower surface of the transparent board 60. The transparent board 60 may be formed from a glass board, and an infrared (IR) blocking filter 66 may be formed on the upper surface of the transparent board 60. With this configuration, optical energy in the IR band(s) is filtered from the light passing through the transparent board 60. The resulting filtered light then illuminates the image sensing unit 52.

In the illustrated example, the image sensing unit 52 is positioned in a center of the upper surface of the image sensing chip 50. A plurality of chip bonding pads 51 are formed around the image sensing unit 52 and communicate electrical signals generated by the image sensor chip 50 to external circuits. Metal bumps 54, formed of a conductive material like gold, are formed on the chip bonding pads 51. However, conductive solder balls may be used instead of the metal bumps 54.

First line layers 61 are formed on the lower surface of the transparent board 60 in electrical contact with the metal bumps 54 formed on the chip bonding pads 51. In the illustrated embodiment, the first line layers 61 include seed metal layers and electroplating layers formed on the seed metal layers. Ti/Cu or Ti/Ni may be sputtered to form the seed metal layers, and the electroplating layers may be formed from Ni, Cu, Au, or the like, on the seed metal layers. The transparent board 60 is formed to have inclining sidewalls.

A predetermined space is formed between the lower surface of the transparent board 60 and the upper surface of the image sensor chip 50 and is sealed by a sealing member 56 formed along the metal bumps 54. To form the sealing member 56, a punching process is performed on an anisotropic conductive film (ACF) to expose the image sensing unit 52 to light, a positioning process is used to align the metal bumps 54 with the first line layers 61, and then a heat pressing process is applied. The sealing member 56 may also be formed of a dam adhesive instead of an epoxy film, such as an ACF or the like.

A sidewall and a lower surface of the image sensor chip 50 bonded to the lower surface of the transparent board 60 are enclosed and fixed by a photosensitive polymer layer 58. The photosensitive polymer layer 58 is formed of a photosensitive polyimide material or may be formed of benzocyclobutene (BCB) which is an insulating material in which through holes may be formed using a photolithography technique.

A plurality of through holes are formed in the photosensitive polymer layer 58 adjacent to sidewalls of the image sensor chip 50, and second line layers 62 are formed in the through holes. The second line layers 62 transmit electrical signals communicated from the chip bonding pads 51 to an external circuit. Like the first line layers 61, the second line layers 62 include seed metal layers and electroplating layers formed on the seed metal layers. Ti/Cu, Ti/Ni, or the like is sputtered to form the seed metal layers, and the electroplating layers are formed of Ni, Cu, Au, or the like on the seed metal layers. The second line layers 62 completely fill the through holes and extend onto the photosensitive polymer layer 58 formed on the lower surface of the image sensor chip 50 to a point a predetermined length toward center of the image sensor chip 50. Conductive connection members 64 are formed on ends of the second line layers 62 for providing electrical connection to the external circuit. In the illustrated embodiment, the conductor connection members 64 may be solder balls or bumps. The conductive connection members 64 may be formed of Au or solder or materials such as Sn/Pb, Sn/Ag, Sn/Ag/Cu, or the like.

A resin layer 68, opaque to incident light, is formed on the outer surface of the photosensitive polymer layer 58 which encloses the sidewalls of the image sensor chip 50. The opaque resin layer 68 prevents light from passing and laterally illuminating the image sensor chip 50, thereby reducing incident optical noise from being generated in the image sensing unit 52.

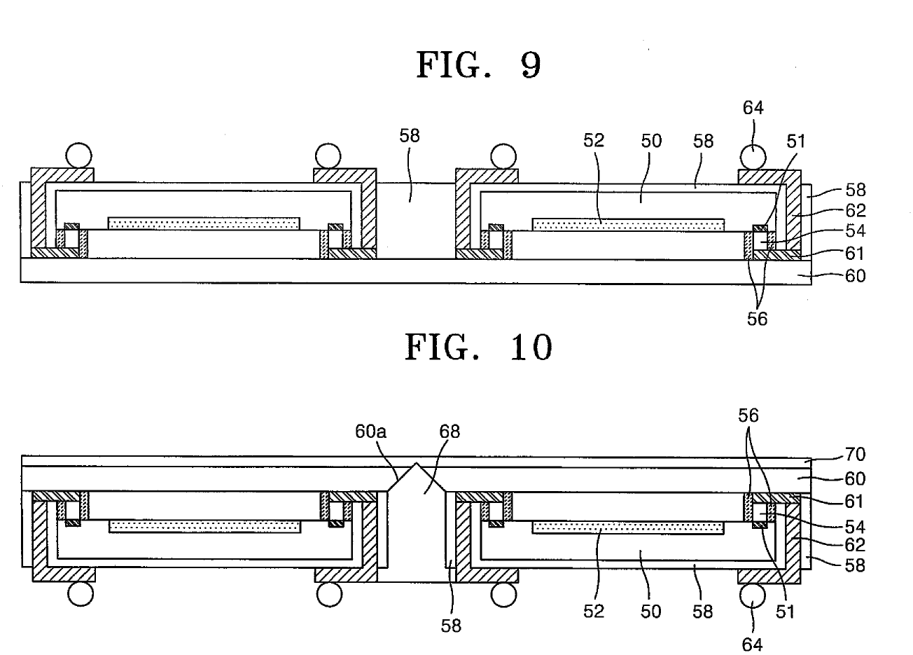

A method of manufacturing an image sensor package according to an embodiment of the invention will now be described with reference to FIGS. 5 through 11.

FIGS. 5 through 11 are related cross-sectional views illustrating a method of manufacturing the image sensor package 100 of FIG. 4 according to an embodiment of the invention. In the following description, the image sensor package 100 is initially formed in an upside-down arrangement, and as such upper portions of the image sensor package 100 as shown in FIG. 4 may appear as lower portions in FIGS. 5 through 9 and the parts of the description to initial part of the following description. For ease of reference, throughout all descriptions portions are referred to as being upper or lower according to the final arrangement of the image sensor package 100 shown in FIG. 4.

Referring to FIG. 5, the first line layers 61 are formed on a first surface of the transparent board 60 which is the lower surface of the image sensor package 100 as described previously with reference to FIG. 4. An IR blocking filter may optionally be coated on a second surface of the transparent board 60 on which the first line layers 61 are not formed, prior to or after the forming of the first line layers. The second surface of the transparent board 60 is the upper surface of the image sensor package 100 as described previously with reference to FIG. 4. In this case, the IR blocking filter may be formed after the manufacture of the image sensor package 100, (i.e., the blocking filter may be formed after an image sensor chip 50 is bonded to the transparent board 60 and before the image sensor chip 50 is singularized). For example, the transparent board 60 may be a glass board having a thickness ranging between 200 μm and 350 μm and having a wafer level size. Various materials having diameters of 4, 6, 8, 10, 12, inches etc. may be selected as the transparent board 60.

The first line layers 61 may be formed using an electroplating technique. In other words, seed metal layers are formed on the entire first surface of the transparent board 60 using a sputtering process. Possible seed metal layers include Ti/Cu, Ti/Au, or Ti/Ni. A photosensitive film is coated on the seed metal layers to form, by using a photolithography technique, photosensitive film patterns exposing the seed metal layers only in parts of the first surface of the transparent board 60 in which the first line layers 61 are to be formed. Next, electroplating layers are formed on the exposed seed metal layers using an electroplating technique. Here, the material used to form the electroplating layers may be a metal such as Ni, Cu, Au, or the like. The first line layers 61 including the seed metal layers and the electroplating layers may be obtained by removing the photosensitive film patterns, and removing the seed metal layers on which the electroplating layers are not formed by wet etching.

Since the transparent board 60 is a wafer level size substrate, a plurality of unit areas each in which an image sensor package is to be formed are formed on the first surface in subsequent processes. In other words, a plurality of first line layers 61 corresponding to chip bonding pads of an image sensor chip constitute a unit area. For example, such unit areas may be formed in an array.

Referring to FIG. 6, the image sensor chip 50 is bonded to the transparent board 60. The image sensing unit 52 is formed in the upper portion of the image sensor chip 50 in advance, and the metal bumps 54 are formed of gold on exposed portions of the chip bonding pads 51 which are formed around the image sensing unit 52. One image sensor chip 50 is separately bonded to a unit area of the transparent board 60 by performing a bonding process.

Before the bonding process is performed, an anisotropic conductive film (ACF) in the form of a sheet is provided. A portion of the ACF corresponding to the image sensing unit 52 of the image sensor chip 50 is removed in a punching process, and thus the ACF is formed into a rectangular band shape. The ACF on which the punching process has been performed is arranged between the first line layers 61 and the metal bumps 54 and then heat pressed to electrically connect the first line layers 61 to the bumps 54. Simultaneously, the ACF encloses the metal bumps 54 and the first line layers 61 and thus remains as the sealing members 56 which seal a space between the lower surface of the transparent board 60 and the image sensing unit 52.

The image sensor chip 50 may be bonded to the transparent board 60 using other bonding methods, (e.g., a supersonic connection technique). Here, the sealing members 56 are formed using the dam adhesive which does not flow into the image sensing unit 52.

As shown in FIG. 6, after the bonding process is performed, the first line layers 61 are exposed to a predetermined length out of sidewalls of the image sensor chip 50.

Referring to FIG. 7, the image sensor chip 50 is bonded onto the transparent board 60, and then the photosensitive polymer layer 58 is formed on an entire upper surface of the resultant structure. Here, the photosensitive polymer layer 58 is formed thickly so as to cover the image sensor chip 50, the exposed first line layers 61, and the sealing members 56. Through holes 59 are formed in portions of the photosensitive polymer layer 58 around the sidewall of the image sensor chip 50 using a general photolithography technique to expose portions of the first line layers 61.

Referring to FIG. 8, a seed metal layer is deposited in the through holes 59 and on the entire surface of the photosensitive polymer layer 58 in which the through holes 59 have been formed, using a sputtering process as described above in a process of forming the first line layers 61. A photosensitive polymer layer such as photoresist is coated on the seed metal layer, and then portions of the photosensitive polymer layer corresponding to portions of the seed metal layer which are to be electroplated are removed using a photolithography technique to expose the seed metal layer. Next, the electroplating layers are formed using an electroplating method, and the photosensitive polymer layer used for electroplating and any excessive seed metal layer is removed. Thus, the through holes 59 are completely filled, and simultaneously, the second line layers 62 are formed to extend along an upper surface of the photosensitive polymer layer 58 of the image sensor chip 50 as shown in FIG. 8. In the above-described process, a pulse plating technique may be used as the electroplating technique to improve a filling degree of the through holes 59.

Referring to FIG. 9, the conductive connection members 64 are formed on the ends of the second line layers 62 for a smooth electrical connection to the external circuit. In the illustrated embodiment, solder balls formed of Sn/Pb, Sn/Ag, Sn/Ag/Cu, or the like are used as the conductive connection members 64. Alternatively, solder bumps may be used as the conductive connection members 64.

Of note, in FIG. 10 the resultant structure of FIG. 9 is shown upside-down in the same orientation as FIG. 4. Referring to FIG. 10, a wafer mounting tape 70 is adhered onto an upper surface of the transparent board 60. The wafer mounting tape 70 has a thickness of at least 100 μm or more. Next, a first cutting process is performed to separate unit image sensor packages formed in unit areas. A large potion of the photosensitive polymer layer 58 formed between adjacent image sensor chips 50 is removed. Thereafter, the transparent board 60 is cut between unit image sensor packages adopting a “V” cut method using a V-shaped blade so that V-shaped slopes 60a are formed during cutting of the transparent board 60. The transparent board 60 is then completely cut into unit areas by cutting into the wafer mounting tape 70 so that a sidewall of the transparent board 60 is completely exposed. An opaque resin layer 68 is completely filled in the resultant hollow portions formed between unit image sensor packages, wherein the opaque resin layer 68 is formed of a material that light does not pass through. The opaque resin layer 68 may be formed of a black epoxy or may be formed of a general epoxy-based opaque resin.

Referring to FIG. 11, a second blocking process is performed to separate unit image sensor packages completed in unit areas. The second blocking process is performed to cut the buried opaque resin layer 68 so that the opaque resin layer 68 remains on sidewalls of the image sensor packages. Thereafter, the wafer mounting tape 70 is removed.

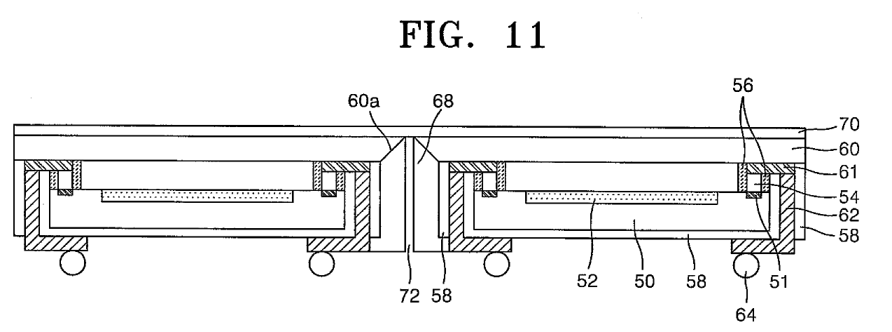

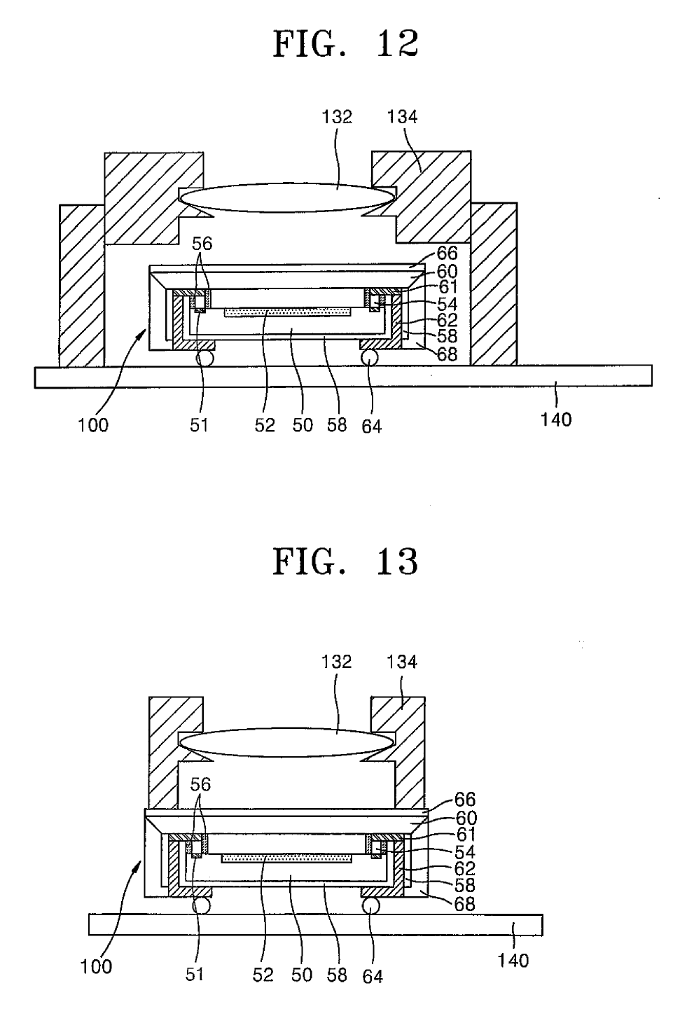

FIGS. 12 and 13 are cross-sectional views of image sensor modules incorporating the image sensor package 100 illustrated in FIG. 4, according to embodiments of the invention.

Referring to FIG. 13, the image sensor package 100 of FIG. 4 is mounted on a circuit board 140 such as a PCB or an FPC. Next, a lens holder 134 into which a lens 32 is inserted is directly mounted on the image sensor package 100 using an adhesive (not shown). Thus, the lens holder 134 can be formed to the same size as the image sensor package 100. Thus, an image sensor module including the image sensor package 100 may be light, thin, short, and/or small.

Referring to FIG. 12, the image sensor package 100 of FIG. 4 is mounted on a circuit board 140 such as a PCB or an FPC. Next, a lens holder 134 into which a lens 132 is inserted is mounted on the circuit board 140 using an adhesive (not shown) so that the image sensor package 100 is included.

As described above, according to embodiments of the invention, first line layers may be connected to second line layers using through holes. Thus, a slight, thin, short, and/or small image sensor package can be easily manufactured.

Also, an opaque resin layer can be formed on a sidewall of an image sensor chip to improve reliability of image sensing.

In addition, a transparent board and the image sensor chip can be sealed by sealing members to reduce possibility of contamination of an image sensing unit.

While the present invention has been particularly shown and described with reference to exemplary embodiments thereof, it will be understood by those of ordinary skill in the art that various changes in form and details may be made therein without departing from the scope of the invention as defined by the following claims.

What is claimed is:

1. An image sensor package comprising:
an image sensor chip comprising an image sensing unit centrally positioned on an upper portion and comprising a plurality of chip bonding pads formed around the image sensing unit;
a transparent board;
a plurality of first line layers formed on a lower surface of the transparent board facing the image sensing unit and electrically connecting the chip bonding pads; and
a plurality of second line layers connected to the first line layers and extending along sidewalls and a bottom surface of the image sensor chip.

2. The image sensor package of claim 1, wherein a plurality of metal bumps are positioned between the chip bonding pads and the first line layers.

3. The image sensor package of claim 2, further comprising:
a sealing member formed between the image sensor chip and the transparent board around the image sensing unit to optically seal a space between the image sensing unit and the lower surface of the transparent board.

4. The image sensor package of claim 3, wherein the sealing member encloses the metal bumps.

5. The image sensor package of claim 1, further comprising:
a photosensitive polymer layer covering the sidewalls of the image sensor chip and the first line layers.

6. The image sensor package of claim 5, wherein the second line layers are formed in through holes formed in the photosensitive polymer layer.

7. The image sensor package of claim 5, wherein the photosensitive polymer covers the lower surface of the image sensor chip.

8. The image sensor package of claim 7, wherein the second line layers extend a predetermined distance along the photosensitive polymer layer formed on the lower surface of the image sensor chip.

9. The image sensor package of claim 1, further comprising:
an opaque resin layer formed on sidewalls of the image sensor chip.

10. The image sensor package of claim 1, further comprising:
an infrared blocking filter formed on an upper surface of the transparent board.

11. The image sensor package of claim 9, wherein the transparent board comprises sides inclined toward the image sensor package, and wherein the opaque resin layer is formed under the sloped sides.

12. The image sensor package of claim 1, further comprising:
solder balls or solder bumps formed in electrical contact with the second line layers.

13. The image sensor package of claim 1, wherein the first line layers and the second line layers comprise at least one seed metal layer and at least one electroplating layer plated on the at least one seed metal layer.

14. An image sensor module comprising:
a circuit board;
an image sensor package mounted on the circuit board;
and a lens unit formed on the image sensor package,
wherein the image sensor package comprises:
an image sensor chip comprising an image sensing unit centrally positioned on an upper portion and comprising a plurality of chip bonding pads formed around the image sensing unit;
a transparent board;
a plurality of first line layers formed on a lower surface of the transparent board facing the image sensing unit and electrically connecting the chip bonding pads; and
a plurality of second line layers connected to the first line layers and extending along sidewalls and a bottom surface of the image sensor chip.

15. The image sensor module of claim 14, wherein the lens unit comprises a lens and a lens holder mounted on the transparent board.

16. The image sensor module of claim 14, wherein the image sensor package further comprises:
a sealing member formed between the image sensor chip and the transparent board around the image sensing unit to optically seal a space between the image sensing unit and the lower surface of the transparent board; and
a photosensitive polymer layer enclosing the sealing member and the sidewalls of the image sensor chip.

17. The image sensor module of claim 14, wherein the second line layers extend a predetermined distance along the lower surface of the image sensor chip.

18. The image sensor module of claim 16, wherein the image sensor package further comprises:
an opaque resin layer formed on sidewalls of the photosensitive polymer layer.

19. The image sensor module of claim 18, wherein the transparent board is formed with sloped sides inclined towards the image sensor package, and the opaque resin layer is formed under the sloped sides.

20. A method of manufacturing an image sensor package, comprising:
providing a plurality of image sensor chips each comprising an image sensing unit centrally positioned on an upper portion and comprising a plurality of chip bonding pads formed around the image sensing unit;
providing a wafer level transparent board;
forming a plurality of unit areas comprising a plurality of first lines corresponding to the plurality of chip bonding pads formed on a lower surface of the transparent board;
bonding the image sensor chips to the unit areas of the transparent board such that the image sensor unit faces the lower surface of the transparent board;
forming a photosensitive polymer layer on the entire surface of the transparent board on which the image sensor chips are bonded;
forming a plurality of through holes inside the photosensitive polymer layer to expose portions of the first line layers;
filling the through holes to form a plurality of second line layers exposed under the respective lower surfaces of the image sensor chips;
adhering the wafer mounting tape on an upper surface of the transparent board;
removing portions of the photosensitive polymer layer and the transparent board between the adjacent unit areas;
filling the removed portions of the photosensitive polymer layer and the transparent board between the adjacent unit areas with an opaque resin layer; and
blocking a portion of the opaque resin layer to separate a plurality of image sensor packages each corresponding to a unit area.

21. The method of claim 20, wherein the providing of the plurality of image sensor chips comprises forming metal bumps on the chip bonding pads.

22. The method of claim 21, wherein an anisotropic conductive film (ACF) having a portion corresponding to the image sensing unit of the image sensor chips removed is provided, positioned between the metal bumps and the first line layers, and pressed to bond the image sensor chips to the unit areas of the transparent board.

23. The method of claim 20, wherein the first and second line layers comprise at least one seed metal layer and at least one electroplating layer.

24. The method of claim 20, wherein the photosensitive polymer layer covers the lower surface of the image sensor chips.

25. The method of claim 24, wherein each of the second line layers extends a predetermined distance toward a center of the lower surface of the corresponding image sensor chip.

26. The method of claim 20, further comprising:
forming an IR blocking filter on the upper surface of the transparent board.

27. The method of claim 20, further comprising:
forming conductive connection members contacting the second line layers.

28. The method of claim 20, wherein the removal of the portions of the transparent board and the photosensitive polymer layer comprises removing a portion of a sidewall of the transparent board to form a slope in the transparent board.

29. The method of claim 20, further comprising:
separating the image sensor packages and removing the wafer mounting tape.

30. The method of claim 20, wherein the chip bonding pads and the metal bumps are arranged to be bonded the image sensor chips to the unit areas of the transparent board using a supersonic connection method.
